(19) United States
(12) Patent Application Publication
(10) Pub. No.: US 2026/0342528 A1
(43) Pub. Date: Oct. 29, 2026

(54) THROUGHPUT BALANCED COEXISTENCE MITIGATION BETWEEN WIRELESS COMMUNICATION PROTOCOLS FOR ELECTRONIC DEVICES

(71) Applicant: Apple Inc., Cupertino, CA (US)

(72) Inventors: Chengzhou LI, Bridgewater, NJ (US); Paul V. FLYNN, Menlo Park, CA (US)

(21) Appl. No.: 19/190,562

(22) Filed: Apr. 25, 2025

(51) Int. Cl. H04L 5/00; H04W 52/34

(52) U.S. Cl. CPC H04L 5/0098; H04W 52/34

(57) ABSTRACT

The subject technology provides for throughput balanced coexistence mitigation between wireless communication protocols for electronic devices. An apparatus can determine that a first frequency band utilized by a first wireless communication protocol is spectrally related to or at least in part affects operation with a second frequency band utilized by a second wireless communication protocol. The apparatus also can, responsive to the determining, obtain a first throughput of the first wireless communication protocol and a second throughput of the second wireless communication protocol. The apparatus also can adjust a transmission parameter associated with the first wireless communication protocol based at least in part on a comparison between the first throughput and the second throughput and apply the adjusted transmission parameter to the first wireless communication protocol. By dynamically performing transmission parameter adjustments for cellular transmissions based on arbitration between throughput capacity estimates, the coexistence interference is mitigated.

### TECHNICAL FIELD

The present description generally relates to wireless communication systems and, in particular to throughput balanced coexistence mitigation between wireless communication protocols for electronic devices.

### BACKGROUND

In modern cellular networks, efficient utilization of network resources and battery power management are beneficial for optimizing user experience and network performance.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 conceptually illustrates an example of a system for performing signaling between a user equipment (UE) and a network entity in an access network in accordance with one or more implementations.

FIG. 3 is a schematic diagram illustrating coexistence between different wireless communication protocols in accordance with one or more implementations.

FIG. 4 is a flow chart of an example process that may be performed by the UE for throughput balanced coexistence mitigation between different wireless communication protocols in accordance with one or more implementations.

FIG. 5 is a schematic diagram illustrating an example of rate estimation and arbitration between different wireless communication protocols in accordance with one or more implementations.

FIG. 6 is a flow chart of an example process that may be performed by the UE for transmission power adjustment in throughput balanced coexistence mitigation between different wireless communication protocols in accordance with one or more implementations.

FIG. 7 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The ubiquity of wireless communication systems underscores their role in delivering a plethora of telecommunication services spanning telephony, video streaming, data transmission, messaging, and broadcasting. These systems, typically leveraging multiple-access technologies, facilitate communication with numerous users by efficiently allocating system resources. These technologies encompass a range of methodologies such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and Time Division Synchronous Code Division Multiple Access (TD-SCDMA).

This versatility in multiple-access technologies has been instrumental in their adoption across various telecommunication standards, establishing a unified protocol that facilitates seamless communication among diverse wireless devices across different geographic scales—from local municipalities to national, regional, and global networks. An example of such standards is the Fifth Generation (5G) New Radio (NR), an integral component of the ongoing mobile broadband evolution spearheaded by the Third Generation Partnership Project (3GPP). 5G NR is designed to meet evolving requirements concerning latency, reliability, security, scalability (including integration with the Internet of Things (IoT)), and other parameters. It encompasses services catering to Enhanced Mobile Broadband (eMBB), Massive Machine Type Communications (mMTC), and Ultra-Reliable Low Latency Communications (URLLC).

In traditional coexistence mitigation between a cellular transmitter and a Wi-Fi transmitter, the cellular transmitter power is typically reduced to maintain Wi-Fi 3 decibel (dB) performance. This mitigation can facilitate that the Wi-Fi transmitter can tolerate only a 3 dB reduction in signal-to-noise ratio due to interference from the cellular signal. With advancements in Wi-Fi standards, such as Wi-Fi 7, the peak throughput of Wi-Fi significantly exceeds that of currently deployed cellular networks, including, for example, 5G NR. Some mitigation approaches can result in an imbalanced performance between cellular and Wi-Fi, where the Wi-Fi transmitter maintains substantially higher throughput than the cellular transmitter after coexistence mitigation. In use cases where both cellular and Wi-Fi transmitters operate simultaneously, cellular performance is often the limiting factor. The conventional mitigation approach can exacerbate this cellular performance bottleneck.

In one or more implementations, embodiments of the subject technology can improve cellular performance by aligning peak Wi-Fi performance with peak cellular performance in these scenarios, which is beneficial for enhancing user experience. For example, a real-time arbiter can arbitrate between cellular and Wi-Fi transmissions. On the cellular side, a cellular rate estimator is utilized, while on the Wi-Fi side, a Wi-Fi rate estimator is employed. The cellular rate estimator collects one or more parameters, including transmission power, transmission power headroom, and the like, to estimate the achievable throughput capacity for cellular transmission. The Wi-Fi rate estimator can collect one or more other parameters, including, for example, channel quality and signal-to-noise-plus-interference ratio to estimate the achievable throughput capacity for Wi-Fi transmission. Both throughput capacity estimates can serve as inputs to the real-time arbiter, which dynamically adjusts the transmission power limit for cellular transmissions to balance cellular and Wi-Fi performance.

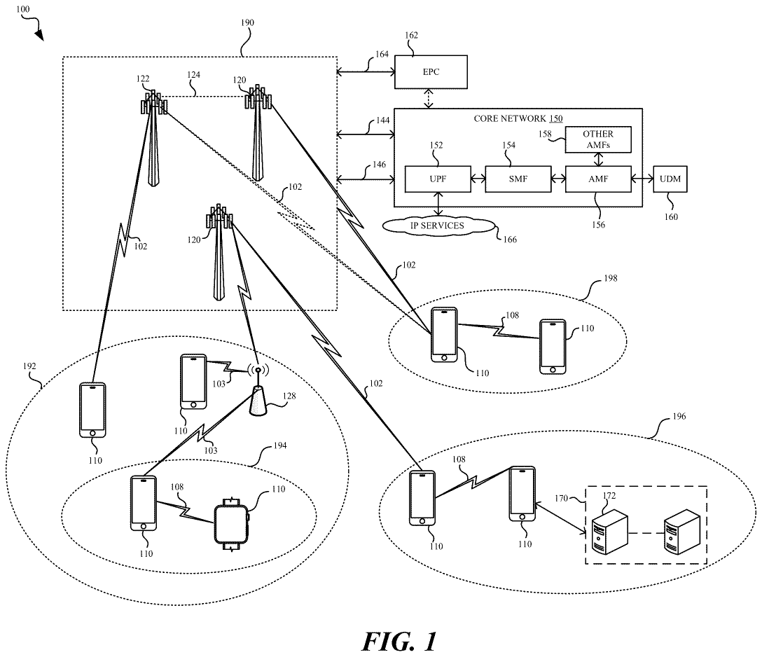

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100 that operates in conjunction with the Long-Term Evolution (LTE) system standards and/or 5G NR system standards as provided by 3GPP technical specifications and other 3GPP documents. The network environment 100 includes a radio access network (RAN) 190 and user equipment(s) (UE) 110. The RAN 190 includes base stations 120 and 122. The base stations may include macrocells and/or small cells (e.g., femtocells, picocells, microcells). The network environment 100 may further include a Wi-Fi access point (AP) 128 in communication with Wi-Fi stations (STAs) via communication links 103, e.g., in a 5 gigahertz (GHz) unlicensed frequency spectrum or the like.

The network environment 100 includes a core network 150 (e.g., a 5G Core) and an Evolved Packet Core (EPC) 162. The core network 150 may include an Access and Mobility Management Function (AMF) 156, other AMFs 158, a Session Management Function (SMF) 154, and a User Plane Function (UPF) 152. The AMF 156 may be in communication with a Unified Data Management (UDM) 160. The AMF 156 is the control node that processes the signaling between the UEs 110 and the core network 150. User IP packets can be transferred through the UPF 152. The UPF 152 provides UE IP address allocation as well as other functions. The UPF 152 is connected to the IP Services 166. The IP Services 166 may include the Internet, an intranet, an IMS, a Packet Switch (PS) Streaming Service, and/or other IP services.

The base stations 120 and 122 configured for 5G NR may interface with the core network 150 through backhaul links (e.g., NG interface). In one or more implementations, the RAN 190 may be connected with the core network 150 via an NG interface (e.g., backhaul links 144, 146). In one or more implementations, one or more of the backhaul links 144, 146 may be split into two parts, an NG user plane (NG-U) interface, which carries traffic data between the base station 120 or base station 122 and a user plane function (UPF) 152, and the S1 control plane (NG-C) interface, which is a signaling interface between the base station 120 or base station 122 and access and mobility management functions (AMFs) 156.

The base stations 120 and 122 configured for LTE may interface with the EPC 162 through backhaul links (e.g., S1 interface). In one or more implementations, the RAN 190 may be connected with the EPC 162 via an S1 interface (e.g., backhaul link 164). In one or more implementations, the backhaul link 164 may be split into two parts, an S1 user plane (S1-U) interface, which carries traffic data between the base station 120 and base station 122 and a serving gateway (S-GW), and the S1-MME interface, which is a signaling interface between the base station 120 or base station 122 and mobility management entities (MMEs).

The base stations 120 and 122 may communicate directly or indirectly (e.g., through the core network 150 or the EPC 162) with each other through backhaul links (e.g., Xn interface, X2 interface). The backhaul links may be wired or wireless. In one or more implementations, the base station 120 or the base station 122 may be configured to communicate with one another via interface 124.

The network entities (e.g., base stations 120 and 122) may wirelessly communicate with the UEs 110. Each of the network entities may provide communication coverage for a respective geographic coverage area (e.g., coverage areas 192, 194, 196, 198). There may be overlapping geographic coverage areas (e.g., coverage areas 192, 194). The communication links 102 between the network entities and the UEs 110 may include uplink transmissions from a UE 110 to a network entity and/or downlink transmissions from a network entity to a UE 110. The communication links 102 may use multiple-input and multiple-output antenna technology, including spatial multiplexing, beamforming, and/or transmit diversity. The communication links may be through one or more component carriers. The component carriers may include a primary component carrier (e.g., primary cell (PCell)) and one or more secondary component carriers (e.g., secondary cell (SCell)). In one or more implementations, the base station 120 may serve as a PCell and the base station 122 may serve as a SCell.

In one or more implementations, the electromagnetic spectrum is subdivided, based on frequency/wavelength, into various classes, bands, channels, or the like. In 5G NR, a first operating band referred to as frequency range 1 or FR1 can include frequencies in the range of 410 MHz to 13.125 GHz, and a second operating band referred to as frequency range 2 or FR2 can include frequencies in the range of 24.25 GHz to 52.6 GHz.

In one or more implementations, UEs 110 may communicate with each other using sidelink communication link 108. The sidelink communication link 108 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and a physical sidelink feedback channel (PSFCH).

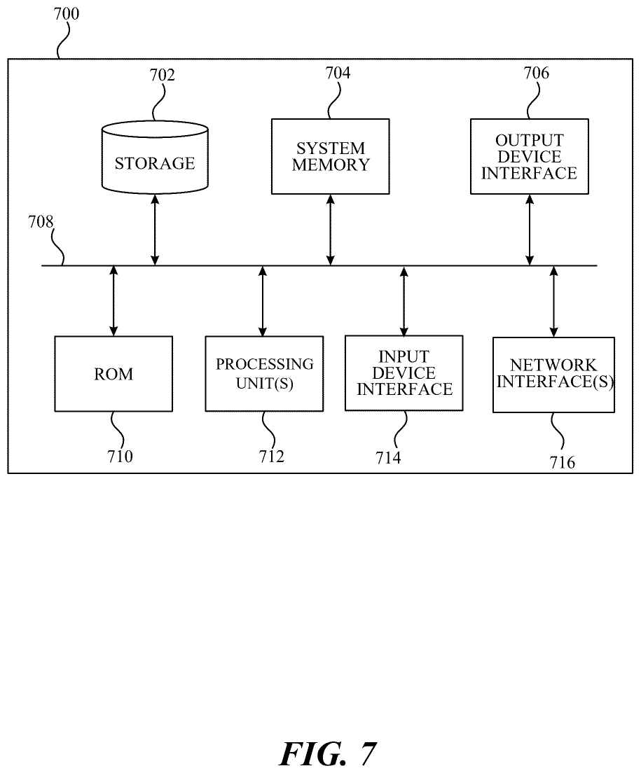

For explanatory purposes, the network environment 100 is illustrated in FIG. 1 as including the UEs 110 and a group of servers 170 in the coverage area 196; however, the network environment 100 may include any number of UEs and any number of servers or a data center including multiple servers in one or more coverage areas of the network environment 100. The UEs 110 may be, and/or may include all or part of, the electronic system discussed below with respect to FIG. 7.

The server 172 may form all or part of a network of computers or the group of servers 170, such as in a cloud computing or data center implementation. For example, the server 172 stores data and software, and includes specific hardware (e.g., processors, graphics processors and other specialized or custom processors) for rendering and generating content such as graphics, images, video, audio and multi-media files. In an implementation, the server 172 may function as a cloud storage server that stores any of the aforementioned content generated by the above-discussed devices and/or the server 172.

The server 172 may provide a system for training a machine learning model using training data, where the trained machine learning model is subsequently deployed to the server 172 and/or to one or more of the UEs 110. In an implementation, the server 172 may train a given machine learning model for deployment to a client electronic device (e.g., the UE 110). In one or more implementations, the server 172 may train portions of the machine learning model that are trained using (e.g., anonymized) training data from a population of users, and one or more of the UEs 110 may train portions of the machine learning model that are trained using individual training data from the user of the UEs 110. The machine learning model deployed on the server 172 and/or one or more of the UEs 110 can then perform one or more machine learning algorithms. In an implementation, the server 172 provides a cloud service that utilizes the trained machine learning model and/or continually learns over time.

In one or more implementations, one or more of the UEs 110 may provide a system for training a machine learning model using training data, where the trained machine learning model is subsequently deployed to one or more of the UEs 110. Further, one or more of the UEs 110 may provide one or more machine learning frameworks for training machine learning models and/or developing applications using such machine learning models. In an example, such machine learning frameworks can provide various machine learning algorithms and models for different problem domains in machine learning. In an example, the UE 110 may include a deployed machine learning model that provides an output of data corresponding to a prediction or some other type of machine learning output. For example, a machine learning model may be used in conjunction with the WiFi rate estimator and/or the cellular rate estimator. In one or more implementations, training and inference operations that involve individually identifiable information of a user of one or more of the UEs 110 may be performed entirely on the UEs 110, to prevent exposure of individually identifiable data to devices and/or systems that are not authorized by the user.

One or more of the network entities may include and/or be referred to as a gNB, Node B, eNB, an access point, a base transceiver station, a radio base station, a radio transceiver, a transceiver function, a basic service set (BSS), an extended service set (ESS), a transmit reception point (TRP), a satellite base station, a base station, a reconfigurable intelligent surface (RIS), or some other suitable terminology without departing from the scope of the present disclosure. Each of the network entities (e.g., base stations 120 and 122) can provide an access point to the EPC 162 or core network 150 for a UE 110.

Examples of UEs 110 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a smart watch, a vehicle, an electric meter, a gas pump, a kitchen appliance, a healthcare device, an implant, a sensor, an actuator, a display, or any other similar functioning device. Some of the UEs 110 may be referred to as Internet-of-Things (IoT) devices. The UE 110 may also be referred to as an electronic device, a station, a mobile station, a subscriber unit, a subscriber station, a mobile subscriber station, a mobile unit, a wireless unit, a remote unit, a mobile device, a wireless device, a wireless communications device, a remote device, an access terminal, a mobile terminal, a wireless terminal, a remote terminal, a handset, a user agent, a mobile client, a client, or some other suitable terminology without departing from the scope of the present disclosure.

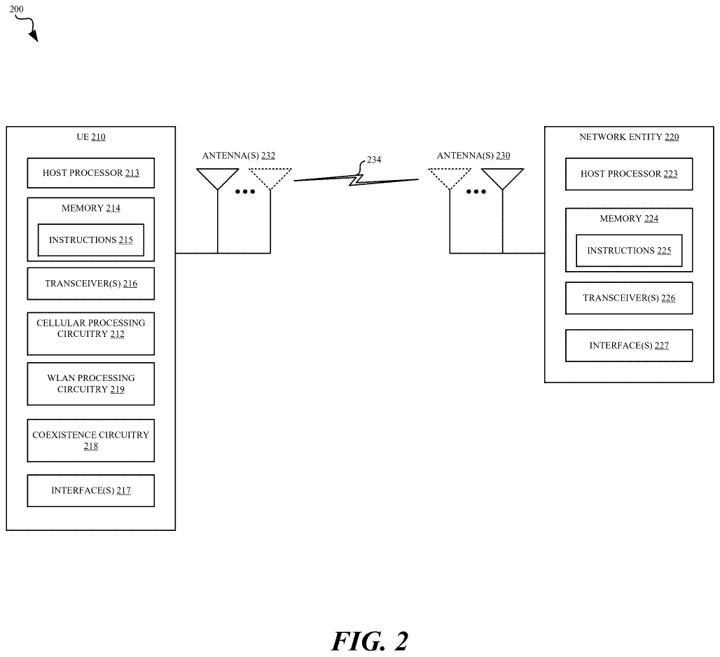

FIG. 2 conceptually illustrates an example of a system 200 for performing signaling between a UE 210 and a network entity 220 in an access network in accordance with one or more implementations. The system 200 may be a portion of the network environment 100. The UE 210 may be, for example, one of the UEs 110 of the network environment 100. The network entity 220 may be, for example, a base station (e.g., an eNB or a gNB) of the network environment 100 that is a base station (e.g., base station 120, 122).

The UE 210 may include a host processor 213. The host processor 213 may execute instructions such that various operations of the UE 210 are performed. For example, the host processor 213 can serve as the CPU responsible for executing instructions and managing various tasks. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The UE 210 may include one or more transceiver(s) 216 that may include radio frequency (RF) transmitter and/or receiver circuitry that use the antenna(s) 232 of the UE 210 to facilitate signaling (e.g., the signaling 234) to and/or from the UE 210 with other devices (e.g., the network entity 220) according to corresponding wireless communication protocols (e.g., cellular, Wi-Fi, Bluetooth). The one or more transceivers 216 can be responsible for both transmitting and receiving radio signals. The one or more transceivers 216 can facilitate wireless communication by converting digital data into radio waves for transmission and then converting received radio waves back into digital data for the UE 210 to process. The one or more transceivers 216 can operate within specific frequency bands allocated for wireless communication and may employ various modulation techniques to optimize data transmission efficiency and reliability. In one or more implementations, the one or more transceiver(s) 216 are not limited to specific wireless communication protocols, including Bluetooth, Thread®, Wi-Fi, cellular, among others, as it is appreciated that other wireless communication protocols and/or technologies can be associated with the one or more transceiver(s) 216.

The UE 210 may include a memory 214. The memory 214 may be a non-transitory computer-readable storage medium that stores instructions 215 (which may include, for example, the instructions being executed by one or more components in the transceiver 216 and/or the host processor 213). The instructions 215 may also be referred to as program code or a computer program. The memory 224 may also store data used by, and results computed by, the transceiver 216 and/or the host processor 213.

The UE 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the RF components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the UE 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

In one or more implementations, the one or more transceivers 216 can operate in conjunction with the cellular processing circuitry 212 to facilitate cellular communication. The one or more transceivers 216 is responsible for converting digital data from the cellular processing circuitry 212 into radio signals for transmission over the air and for receiving incoming radio signals, which are then converted back into digital data for processing by the cellular processing circuitry 212. This collaboration enables the UE 210 to transmit and receive data, supporting functions such as voice calls, text messaging, internet access, and other wireless services. The cellular processing circuitry 212 manages the digital signal processing tasks, while the one or more transceivers 216 handle the analog RF operations, working together to enable wireless communication capabilities in the UE 210.

The UE 210 may include WLAN processing circuitry 219. The WLAN processing circuitry 219 is responsible for managing the transmission and reception of wireless signals to and from mobile devices (e.g., UE 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the UE 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the WLAN processing circuitry 219 to facilitate Wi-Fi communication. The one or more transceivers 216 is responsible for converting digital data from the WLAN processing circuitry 219 into radio signals for transmission over the air and for receiving incoming radio signals, which are then converted back into digital data for processing by the WLAN processing circuitry 219. This collaboration enables the UE 210 to transmit and receive data, supporting functions such as voice calls, text messaging, Internet access, and other wireless services via Wi-Fi. The WLAN processing circuitry 219 manages the digital signal processing tasks, while the one or more transceivers 216 handle the analog RF operations, working together to enable wireless communication capabilities in the UE 210.

The UE 210 may include one or more antenna(s) 232 (e.g., one, two, four, or more). In implementations having multiple antenna(s) 232, the UE 210 may perform multiple-in-multiple-out (MIMO), digital beamforming, analog beamforming, beam steering, etc. For implementations with multiple antenna(s) 232, the UE 210 may leverage the spatial diversity of such multiple antenna(s) 232 to send and/or receive multiple different data streams on the same time and frequency resources.

The UE 210 may include one or more interface(s) 217. The interface(s) 217 may be used to provide input to or output from the UE 210. For example, UE 210 that is a UE may include interface(s) 217 such as microphones, speakers, a touchscreen, buttons, and the like to allow for input and/or output to the UE by a user of the UE. Other interfaces of such a UE may be made up of made up of transmitters, receivers, and other circuitry (e.g., other than the transceiver(s) 216/antenna(s) 232 already described) that allow for communication between the UE and other devices and may operate according to known protocols (e.g., Wi-Fi®, Bluetooth®, and the like).

The UE 210 may include coexistence circuitry 218. The coexistence circuitry 218 may be implemented via hardware, software, or combinations thereof. For example, the coexistence circuitry 218 may be implemented as a processor, circuit, and/or instructions 215 stored in the memory 214 and executed by the host processor 213 and/or the transceiver 216. In some examples, the coexistence circuitry 218 may be integrated within the transceiver(s) 216. For example, the coexistence circuitry 218 may be implemented by a combination of software components (e.g., executed by a DSP or a general processor) and hardware components (e.g., logic gates and circuitry) within the transceiver(s) 216. In other examples, the coexistence circuitry 218 is a separate component from the transceiver(s) 216. In other examples, the coexistence circuitry 218 may be integrated within the cellular processing circuitry 212.

The coexistence circuitry 218 may be used for various aspects of the present disclosure, for example, aspects of FIG. 1 through FIG. 7. The coexistence circuitry 218 is configured to, for example, determine that a first frequency band utilized by a first wireless communication protocol at least partially overlaps or is adjacent to a second frequency band utilized by a second wireless communication protocol. The coexistence circuitry 218 is also configured to, for example, responsive to the determining, obtain a first throughput of the first wireless communication protocol and a second throughput of the second wireless communication protocol. The coexistence circuitry 218 is also configured to, for example, adjust a transmission parameter associated with the first wireless communication protocol based at least in part on a comparison between the first throughput and the second throughput. The coexistence circuitry 218 is also configured to, for example, apply the adjusted transmission parameter to the first wireless communication protocol.

The network entity 220 may include a host processor 223. The host processor 223 may execute instructions such that various operations of the network entity 220 are performed. For example, the host processor 223 can serve as the central processing unit (CPU) responsible for executing instructions and managing various tasks. The host processor 223 can include multiple cores, each capable of handling multiple threads simultaneously, enabling multitasking. The host processor 223 can integrate various components such as ALUs, registers, cache memory, and control units to execute instructions and process data. Additionally, the host processor 223 can include integrated DSPs, GPUs, NPUs, and hardware accelerators. The host processor 223 may be implemented using, for example, an ASIC, a controller, a FPGA device, another hardware device, a firmware device, or any combination thereof configured to perform the operations described herein.

The network entity 220 may include a memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the transceiver 226 and/or the host processor 223.

The network entity 220 may include one or more transceiver(s) 226 that may include RF transmitter and/or receiver circuitry that use the antenna(s) 230 of the network entity 220 to facilitate signaling (e.g., the signaling 234) to and/or from the network entity 220 with other devices (e.g., the UE 210) according to corresponding wireless communication protocols (e.g., cellular, Wi-Fi, Bluetooth). The one or more transceivers 226 can be responsible for both transmitting and receiving radio signals. The one or more transceivers 226 can facilitate wireless communication by converting digital data into radio waves for transmission and then converting received radio waves back into digital data for the network entity 220 to process. The one or more transceivers 226 can operate within specific frequency bands allocated for wireless communication and may employ various modulation techniques to optimize data transmission efficiency and reliability. In one or more implementations, the one or more transceiver(s) 226 are not limited to specific wireless communication protocols, including Bluetooth, Thread®, Wi-Fi, cellular, among others, as it is appreciated that other wireless communication protocols and/or technologies can be associated with the one or more transceiver(s) 226.

The network entity 220 may include one or more antenna(s) 230 (e.g., one, two, four, or more). In implementations having multiple antenna(s) 230, the network entity 220 may perform multiple-in-multiple-out (MIMO), digital beamforming, analog beamforming, beam steering, etc.

The network entity 220 may include one or more interface(s) 227. The interface(s) 227 may be used to provide input to or output from the network entity 220. For example, a network entity 220 may include interface(s) 227 made up of transmitters, receivers, and other circuitry (e.g., other than the transceiver(s) 226/antenna(s) 230 already described) that enables the network entity 220 to communicate with other equipment in the core network 150, and/or that enables the network entity 220 to communicate with external networks, computers, databases, and the like for purposes of operations, administration, and maintenance of the network entity 220 or other equipment operably connected thereto.

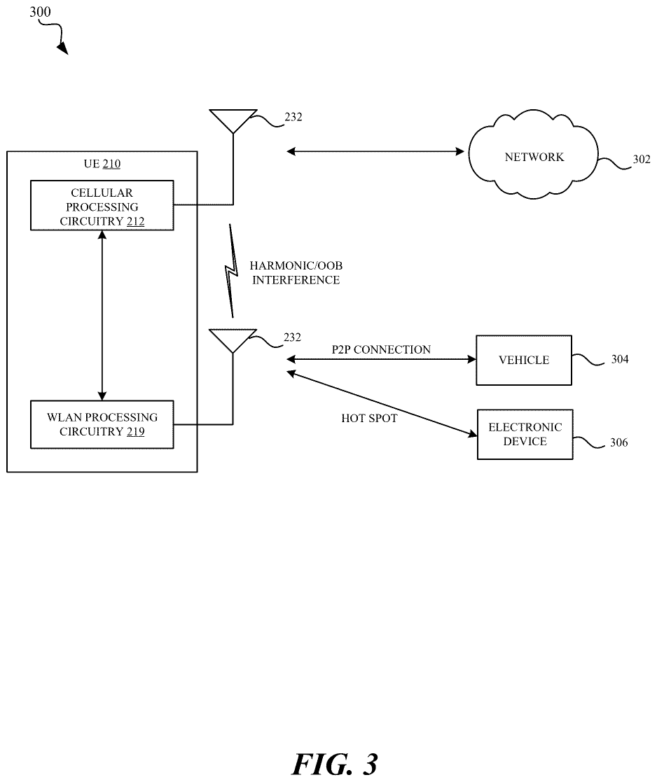

FIG. 3 is a schematic diagram 300 illustrating coexistence between different wireless communication protocols in accordance with one or more implementations. As illustrated in FIG. 3, a UE (e.g., the UE 210) includes a cellular transmitter (e.g., the cellular processing circuitry 212) and a Wi-Fi transmitter (e.g., the WLAN processing circuitry 219). The cellular processing circuitry 212 and the WLAN processing circuitry 219 are communicatively coupled to one another within the UE 210 such that data or control information may be exchanged between the respective processing circuitries. The cellular processing circuitry 212 is coupled to a first antenna 232, and the WLAN processing circuitry 219 is coupled to a second antenna 232, in which each antenna may be configured to facilitate wireless communication over its corresponding radio access technology.

The cellular processing circuitry 212 may perform operations enabling the UE 210 to establish and maintain wireless communication with a cellular network 302, which may include, but is not limited to, a 3GPP-compliant network such as LTE or 5G NR. Such operations may include modulation and demodulation, encoding and decoding, radio resource management, and protocol stack processing in accordance with cellular communication standards.

The WLAN processing circuitry 219 may enable the UE 210 to establish and maintain a wireless communication link with, for example, a vehicle 304 or with an electronic device 306, in which the communication may be conducted according to, for example, IEEE 802.11 standards or other short-range wireless protocols. In one or more implementations, the WLAN communication link may support functions including direct data exchange, peer-to-peer connectivity, or coordination of network-related parameters with external devices located in proximity to the UE 210.

The configuration of the UE 210 may allow for simultaneous or coordinated operation of the cellular processing circuitry 212 and the WLAN processing circuitry 219, supporting multi-radio access and enabling the UE 210 to selectively or concurrently interact with both wide-area cellular networks and localized wireless devices or systems.

The subject technology relates to scenarios involving network coupling and mobile hotspot configurations. In such configurations, the UE 210 can receive data from the network 302 via the cellular processing circuitry 212 and subsequently relays the data via the WLAN processing circuitry 219 to the vehicle 304 or the electronic device 306. In this arrangement, both cellular communication and WLAN communication are concurrently active, with the network 302 providing external connectivity through the cellular processing circuitry 212, and the WLAN processing circuitry 219 enabling local communication with proximate devices, including the vehicle 304 or the electronic device 306 such as a mobile device within a residential or vehicular environment.

Coexistence issues between the cellular processing circuitry 212 and the WLAN processing circuitry 219 may arise, for example, due to the presence of harmonic and intermodulation interference. For example, during operation in 3GPP Band 18, third-order harmonic interference may be observed at a frequency near 2.4 GHz, which corresponds to a commonly used frequency band for Wi-Fi communication. Similarly, operation within Band 41 can result in out-of-band (OOB) interference affecting the 2.4 GHz Wi-Fi spectrum, and Band 79 operation may introduce interference in the 5 GHz Wi-Fi spectrum.

In one or more implementations, mitigating the identified interference may involve implementing a reduction in the cellular transmission (TX) power from the cellular processing circuitry 212. Reducing the cellular TX power directly can attenuate the power level of the generated harmonic and intermodulation signals, decreasing the likelihood of interference with the WLAN processing circuitry 219 and preserving the integrity of Wi-Fi communication performance.

The process for determining the magnitude of TX power reduction needed to mitigate interference may be conducted through empirical hardware evaluation. In one or more implementations, a series of lineup tests can be performed by hardware validation personnel using a statistically significant sample of UE 210 units. During these tests, the cellular processing circuitry 212 may be configured to operate at maximum TX power, and measurements can be collected to quantify the degradation experienced by WLAN communication performance, such as signal-to-noise ratio (SNR) or throughput reduction. Based on these measurements, a fixed TX power cap can be derived such that the degradation in WLAN performance does not exceed a predetermined TX power threshold, for instance, a 3 dB reduction in SNR for 90 percent of the evaluated devices. The resulting TX power limit can be codified into a fixed value and applied to production devices through a lookup table. This lookup table enforces band-specific TX power limitations such that, upon detection of operation within certain cellular frequency bands, the cellular processing circuitry 212 can be constrained to operate at or below the predetermined TX power threshold.

In one or more other implementations, the fixed TX power cap defined by the lookup table may not dynamically account for variations in WLAN-specific use cases or thermal operating conditions of the UE 210. For example, the WLAN processing circuitry 219 may be configured to operate under an assumed Wi-Fi SNR of 30 dB, allowing for communication at a maximum theoretical data rate of approximately 10,000 Mbps. In a coexistence scenario, for example, application of the fixed TX power cap can result in a 3 dB reduction in Wi-Fi SNR, leading to a resultant Wi-Fi data rate of approximately 900 Mbps. This Wi-Fi throughput may remain significantly higher than typical cellular data rates achievable in the network 302. In hotspot-related use cases, for example, cellular data throughput may constitute a performance bottleneck. Therefore, applying a fixed TX power cap that reduces cellular throughput while allowing Wi-Fi to operate at a disproportionately higher throughput may result in a suboptimal allocation of resources. Therefore, it is desirable to implement a dynamic TX power control mechanism such that WLAN throughput does not exceed cellular link capacity beyond a predefined margin, achieving a balanced and efficient distribution of data rates across the cellular and WLAN communication links of the UE 210.

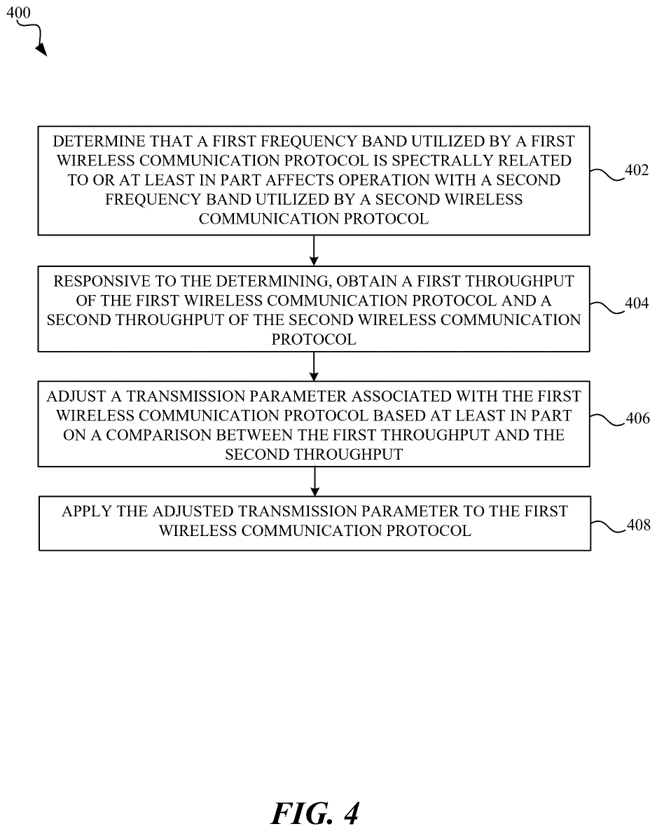

FIG. 4 is a flow chart of an example process that may be performed by a UE (e.g., UE 110, 210) for throughput balanced coexistence mitigation between different wireless communication protocols in accordance with one or more implementations. For explanatory purposes, the process 400 is primarily described herein with reference to an apparatus. However, the process 400 is not limited to the apparatus, and one or more blocks (or operations) of the process 400 may be performed by one or more other components of other suitable devices and/or servers. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

In one or more implementations, the apparatus of FIG. 4 includes a coexistence manager (e.g., coexistence circuitry 218 of FIG. 2). In one or more implementations, the apparatus implemented as the coexistence circuitry 218 may be part of the transceiver(s) 216. In one or more other implementations, the apparatus implemented as the coexistence circuitry 218 may be separate from the transceiver(s) 216. In one or more other implementations, the apparatus of FIG. 4 includes a cellular transmitter (e.g., cellular processing circuitry 212 of FIG. 2) (also referred to as a modem) coupled to a cellular transceiver (e.g., one or more transceivers 216 of FIG. 2). The apparatus communicates using the cellular baseband processor through the cellular transceiver with other UEs and/or network entities via a cellular communication. In one or more implementations, the apparatus is a modem chip and includes only the cellular baseband processor. In one or more other implementations, the apparatus is the entire UE and includes additional modules (e.g., UE 110). In one or more other implementations, the apparatus of FIG. 4 includes a Wi-Fi transmitter (e.g., WLAN processing circuitry 219 of FIG. 2) coupled to a Wi-Fi transceiver (e.g., one or more transceivers 216 of FIG. 2). The apparatus communicates using the Wi-Fi processor through the Wi-Fi transceiver with other UEs and/or network entities via a Wi-Fi communication. In this regard, the apparatus may perform coexistence mitigation between the cellular transmitter and the Wi-Fi transmitter.

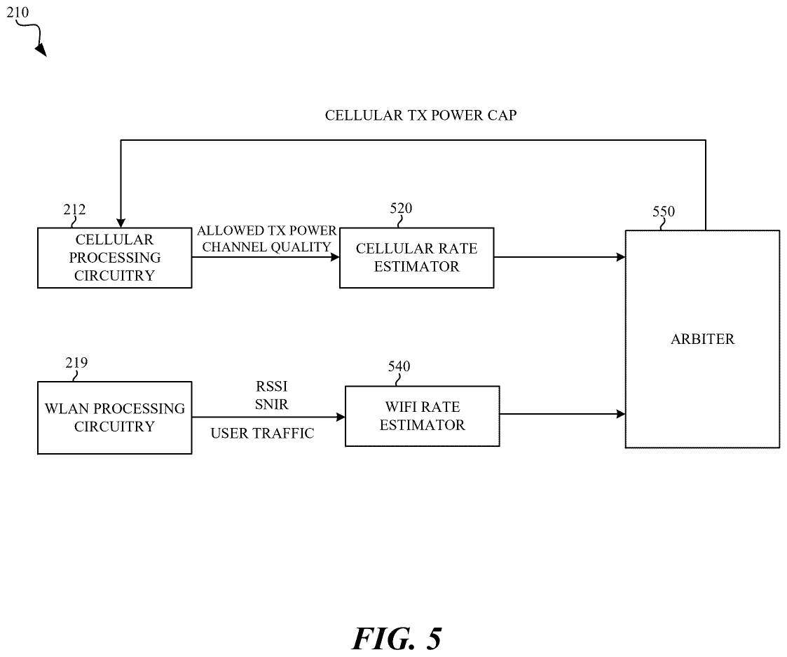

FIG. 5 is a schematic diagram illustrating an example of rate estimation and arbitration between different wireless communication protocols in accordance with one or more implementations. As illustrated in FIG. 5, the cellular processing circuitry 212 and WLAN processing circuitry 219 are communicatively coupled within the UE 210 and are respectively configured to exchange information relevant to system coordination and communication performance. The cellular processing circuitry 212 may be operatively coupled to a cellular rate estimator 520 and an arbiter 550. The WLAN processing circuitry 219 may be operatively coupled to a Wi-Fi rate estimator 540. In one or more implementations, the cellular rate estimator 520 and the Wi-Fi rate estimator 540 may be functional components used to facilitate handover or selection decisions between cellular and WLAN interfaces. In one or more other implementations, the cellular rate estimator 520 and the Wi-Fi rate estimator 540 may employ machine learning models to analyze multi-dimensional input data and infer throughput estimations and connection preferences. In one or more implementations, the cellular rate estimator 520 and the Wi-Fi rate estimator 540 and the arbiter 550 are co-located within an application processor of the UE 210 or the transceiver(s) 216 to enable direct access to channel and traffic data from the cellular and WLAN subsystems, allowing for low-latency control decisions.

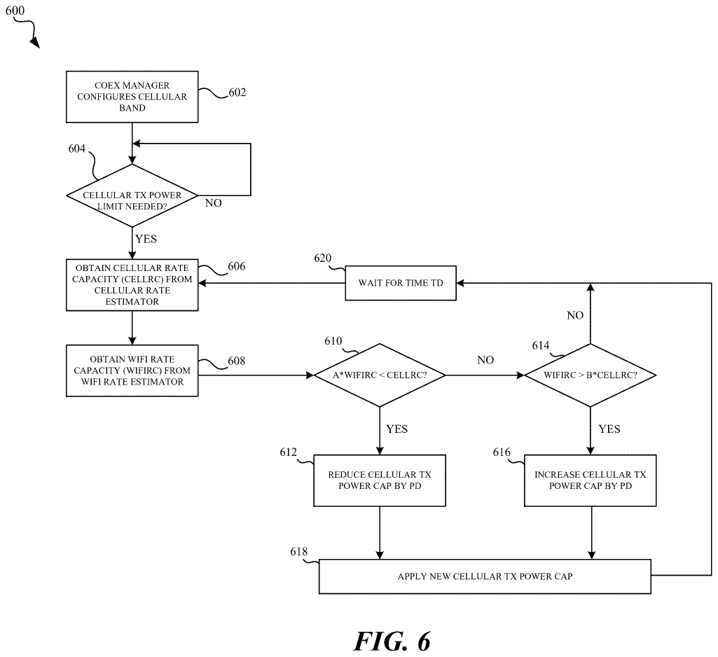

In one or more implementations, the process 400 of FIG. 4 will be discussed with reference to FIG. 5 and FIG. 6. The coexistence circuitry 218 may determine the applicability of a TX power limitation for specific cellular frequency bands. When such a limitation is applicable, the cellular rate estimator 520 and Wi-Fi rate estimator 540—operatively coupled to the cellular processing circuitry 212 and WLAN processing circuitry 219, respectively—may generate throughput estimations based on current operational parameters. These parameters include, for example, TX power, TX power headroom, channel quality, and signal-to-noise characteristics. A throughput allocation parameter, denoted as a, is introduced to define a fractional allocation of Wi-Fi throughput relative to combined throughput. In one or more implementations, parameters a and b may be adjustable coefficients determined through empirical data analysis. In cases where the Wi-Fi throughput is estimated to be below a threshold level in comparison to the estimated cellular throughput, the arbiter 550 can transmit a control signal to reduce the TX power of the cellular processing circuitry 212 in discrete increments. Conversely, if the Wi-Fi throughput exceeds the threshold level, the arbiter 550 may increase the cellular TX power, subject to predefined constraints. In one or more implementations, this evaluation and control process can be executed in a recurring loop, providing a dynamic TX power control mechanism to maintain operational coexistence between the WLAN and cellular subsystems.

The cellular processing circuitry 212 may be configured to provide the cellular rate estimator 520 with parameters including, but not limited to, allowed cellular transmission (TX) power, TX power headroom, and cellular channel quality indicators such as signal-to-interference-plus-noise ratio (SINR), reference signal received power (RSRP), and modulation and coding scheme (MCS) metrics. The cellular rate estimator 520 utilizes these parameters to calculate a cellular throughput estimation representing the expected data transmission rate achievable over the network 302 under current operating conditions. In one or more implementations, this cellular throughput estimation is provided as input to the arbiter 550. In one or more implementations, the coexistence circuitry 218 may include one or more of the cellular rate estimator 520, the Wi-Fi rate estimator 540, or the arbiter 550.

In parallel, the WLAN processing circuitry 219 can provide the Wi-Fi rate estimator 540 with WLAN-related parameters including received signal strength indication (RSSI), signal-to-noise-and-interference ratio (SNIR), and indicators of user traffic load or data activity levels. In one or more implementations, the Wi-Fi rate estimator 540 may employ machine learning-based analysis to identify traffic patterns within the user traffic models and derive accurate estimations. The Wi-Fi rate estimator 540 can process these parameters to generate a Wi-Fi throughput estimation reflecting the current expected throughput of the WLAN communication link between the UE 210 and an external device, such as the vehicle 304 of FIG. 3 or the electronic device 306 of FIG. 3. In one or more implementations, this Wi-Fi throughput estimation is provided as input to the arbiter 550.

The arbiter 550 may be configured to receive and evaluate both the cellular throughput estimation from the cellular rate estimator 520 and the Wi-Fi throughput estimation from the Wi-Fi rate estimator 540. Based on the comparative analysis of these estimations, the arbiter 550 can determine an appropriate control signal that includes a fixed TX power cap value, selected to balance the performance of the cellular and WLAN communication interfaces based on current channel and usage conditions. This control signal may be sent to the cellular processing circuitry 212 and is used to adjust the TX power of the cellular transmission to manage coexistence with the concurrently operating WLAN interface. The TX power adjustment is applied dynamically to maintain a tradeoff between cellular and Wi-Fi throughput, supporting coexistence in shared or interference-prone operational environments.

FIG. 6 is a flow chart of an example process 600 that may be performed by a UE (e.g., UE 110, 210) for transmission power adjustment in throughput balanced coexistence mitigation between different wireless communication protocols in accordance with one or more implementations. For explanatory purposes, the process 600 is primarily described herein with reference to an apparatus. However, the process 600 is not limited to the apparatus, and one or more blocks (or operations) of the process 600 may be performed by one or more other components of other suitable devices and/or servers. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

Referring back to FIG. 4, at block 402, an apparatus (e.g., UE 110; coexistence circuitry 218; arbiter 550) determines that a first frequency band utilized by a first wireless communication protocol (e.g., cellular) is at least spectrally related to or at least in part affects operation with a second frequency band utilized by a second wireless communication protocol (e.g., Wi-Fi), and/or that another coexistence interference criteria is met. In one or more implementations, this determination may be further based on whether the first frequency band produces harmonic components, intermodulation products, or other spectral artifacts that interfere with or otherwise impact signal integrity or performance within the second frequency band. Such spectral relationships may include not only direct frequency overlap but also indirect coupling through non-linear distortion mechanisms, including but not limited to second-order and third-order intermodulation effects, harmonic generation, or passive intermodulation resulting from system-level interactions. This determination may further account for both in-band and OOB emissions as well as their effects on adjacent channel interference, spurious emissions, and system coexistence constraints. For example, referring to block 602 of FIG. 6, the coexistence circuitry 218 may configure a currently active cellular frequency band. In one or more other implementations, the coexistence circuitry 218 may determine that the cellular frequency band is in use.

At block 604, the initial processing decision within the coexistence circuitry 218 may involve determining whether a TX power limitation is beneficial for the currently active cellular frequency band. Coexistence conditions may be encountered when concurrent transmissions from the cellular processing circuitry 212 and WLAN processing circuitry 219 occur within overlapping or adjacent frequency bands. In one or more other implementations, in instances of temporal inactivity on either the cellular or WLAN communication path, coexistence mitigation may be temporarily suspended. Such short-term inactivity intervals may not trigger control adjustments. In one or more other implementations, longer-term coexistence conditions may be observed when the UE 210 remains stationary, maintaining operation within a limited set of frequency bands. Mobility between network cells or transitions between frequency bands can lead to entry into or exit from coexistence scenarios. Certain bands, such as 3GPP Bands 41 and 79, may exhibit limited coverage, resulting in a higher likelihood of transitioning out of coexistence conditions. Other bands located closer to WLAN frequencies, including those operating at 2.4 GHz or 5 GHz, may be more likely to exhibit sustained coexistence interference.

In one or more implementations, the decision to impose TX power limitations may be based on pre-characterization testing conducted during hardware validation phases. UE 210 units may be tested across multiple frequency bands to identify those frequency bands that are susceptible to coexistence interference. Based on these results, a lookup table can be generated that specifies fixed TX power caps for the identified frequency bands. When the UE 210 operates within a listed frequency band, the arbiter 550 may apply the associated TX power cap via a control signal to the cellular processing circuitry 212. If the frequency band in use does not present interference with WLAN frequencies, no TX power limitation may be applied, and the UE 210 may continue to operate without coexistence adjustments.

If the determination is affirmative, the process 600 can continue to blocks 606 and 608 along a mitigation path involving the estimators (e.g., the cellular rate estimator 520 and the Wi-Fi rate estimator 540) and arbiter logic (e.g., arbiter 550). If no interference condition is detected, the process 600 can bypass coexistence control, and no TX power modification may be performed.

Referring back to FIG. 4, at block 404, the apparatus, responsive to the determining, obtains a first throughput of the first wireless communication protocol and a second throughput of the second wireless communication protocol. For example, at block 606 of FIG. 6, the arbiter 550 obtains the first throughput of the first wireless communication protocol (e.g., CellRC) from the cellular rate estimator 520. The cellular rate estimator 520 may estimate a transmission rate of the first wireless communication protocol (e.g., cellular) using one or more of a channel quality indicator (CQI) or a power headroom report. At block 608 of FIG. 6, the arbiter 550 also obtains the second throughput of the second wireless communication protocol (e.g., WifiRC) from the Wi-Fi rate estimator 540. The Wi-Fi rate estimator 540 may estimate a transmission rate of the second wireless communication protocol using a received signal strength indicator or a received signal-to-noise-plus-interference ratio.

In one or more other implementations, the apparatus can configure a plurality of coexistence parameters. The plurality of coexistence parameters may include a first coexistence parameter a representing an adjustment threshold for transmission power associated with the first wireless communication protocol (e.g., cellular) based on an interference condition associated with the second wireless communication protocol (e.g., Wi-Fi). The plurality of coexistence parameters may include a second coexistence parameter b representing an adjustment threshold for transmission power associated with the second wireless communication protocol (e.g., Wi-Fi) based on an interference condition associated with the first wireless communication protocol (e.g., cellular).

Referring back to FIG. 4, at block 406, the apparatus adjusts a transmission parameter associated with the first wireless communication protocol based at least in part on a comparison between the first throughput and the second throughput. In one or more implementations, the transmission parameter comprises a transmission power limit.

In one or more implementations, the comparison between the first throughput and the second throughput may include the apparatus determining that the second throughput combined with the first coexistence parameter is smaller than the first throughput. For example, referring to block 610 of FIG. 6, the arbiter 550 may determine whether a*WifiRC<CellRC. If a*WifiRC is greater, then the process 600 proceeds to block 612. Otherwise, the process 600 proceeds to block 614.

In one or more implementations, adjusting the transmission parameter may include the apparatus reducing the transmission parameter by a predetermined power adjustment step based on the second throughput combined with the first coexistence parameter being smaller than the first throughput. For example, referring to block 612 of FIG. 6, the arbiter 550 may reduce the cellular TX power cap by P_{d} such that P=min(P−P_{d}, Pₘᵢₙ).

In one or more other implementations, the comparison between the first throughput and the second throughput may include the apparatus determining that the second throughput is greater than the first throughput combined with the second coexistence parameter. For example, referring to block 614 of FIG. 6, the arbiter 550 may determine whether WifiRC>b*CellRC. If WifiRC is greater, then the process 600 proceeds to block 616. In one or more other implementations, the apparatus may refrain from adjusting the transmission parameter based on the comparison indicating that the first throughput corresponds to the second throughput. In this regard, the process 600 may proceed to block 620.

In one or more other implementations, adjusting the transmission parameter may include the apparatus increasing the transmission parameter by a predetermined power adjustment step based on the second throughput being greater than the first throughput combined with the second coexistence parameter. For example, referring to block 616 of FIG. 6, the arbiter 550 may increase the cellular TX power cap by P_{d} such that P=max(P+P_{d}, Pₘₐₓ).

In one or more implementations, the coexistence parameters a and b may be adjustable configuration values representing fractional weights used by the arbiter 550 to allocate throughput budgets between the cellular and WLAN communication paths. These parameters may be represented as percentages and may be selected based on empirical data obtained through testing and simulation. In one or more implementations, Wi-Fi rate capacity may substantially exceed cellular rate capacity such that an initial value for parameter a may be set to approximately 0.5. In one or more other implementations, specific operational values can be determined through experimental tuning.

The coexistence parameters a and b may be implemented as either fixed or reconfigurable variables, depending on the configuration of the UE 210. In operational cases where the estimated Wi-Fi rate capacity (e.g., WifiRC) and cellular rate capacity (e.g., CellRC) are similar, dynamic adjustment of parameters a and b can be performed. These adjustments can be executed between transmission duration (T_{d}) cycles or when changes in frequency band usage render coexistence control unnecessary. Optimal configuration of the parameters a and b can facilitate responsive yet stable control behavior, preventing either latency in power adjustments or oscillatory effects due to overcorrection.

The parameter P_{d} may define a step size, in decibels (dB), used by the arbiter 550 to adjust the TX power of the cellular processing circuitry 212. In one or more implementations, the value of P_{d} can be selected based on empirical field test data. Testing may be conducted to observe the impact of TX power changes in increments such as 1 dB, 2 dB, or 3 dB. Larger P_{d} values may induce oscillations in throughput or interference behavior. In this regard, smaller step sizes, for example 0.5 dB, may be beneficial to facilitate stable and gradual power control.

The T_{d} parameter may define an interval between consecutive transmission adjustments, during which WLAN packet transmissions are permitted to complete before TX power modifications are applied. In one or more other implementations, the T_{d} parameter may be set to values on the order of several seconds, such as 2 to 3 seconds, to facilitate that WLAN throughput is not disrupted by rapid changes in cellular transmission behavior.

Referring back to FIG. 4, at block 408, the apparatus applies the adjusted transmission parameter to the first wireless communication protocol. For example, referring to block 618 of FIG. 6, the arbiter 550 may apply the new cellular TX power cap. In one or more implementations, the applying includes applying without changing the first frequency band.

In one or more other implementations, the apparatus may wait for a predefined duration after applying the adjusted transmission parameter to the transmission before obtaining new throughput estimates associated with the first wireless communication protocol and the second wireless communication protocol. For example, at block 620 of FIG. 6, the arbiter 550 may for wait for a duration of T_{d}. In one or more implementations, this evaluation and control process can be executed in a recurring loop, providing a dynamic TX power control mechanism to maintain operational coexistence between the WLAN and cellular subsystems.

FIG. 7 illustrates an electronic system 700 with which one or more implementations of the subject technology may be implemented. The electronic system 700 can be, and/or can be a part of, the UE 110, and/or the base station 120 shown in FIG. 1. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a flash drive, and its corresponding solid-state drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710. From these various memory units, the one or more processing unit(s) 712 retrieves instructions to execute and data to process in order to execute the processes of one or more implementations.

The bus 708 also connects to the input device interface 714 and output device interface 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to one or more networks and/or to one or more network nodes, such as the UE 110 shown in FIG. 1, through the one or more network interface(s) 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method of mitigating coexistence between different wireless communication protocols in an electronic device, the method comprising:
determining that a first frequency band utilized by a first wireless communication protocol is at least spectrally related to or at least in part affects operation with a second frequency band utilized by a second wireless communication protocol;
responsive to the determining, obtaining a first throughput of the first wireless communication protocol and a second throughput of the second wireless communication protocol;
adjusting a transmission parameter associated with the first wireless communication protocol based at least in part on a comparison between the first throughput and the second throughput; and
applying the adjusted transmission parameter to the first wireless communication protocol.

2. The method of claim 1, wherein the transmission parameter comprises a transmission power limit.

3. The method of claim 1, wherein the applying comprises applying without changing the first frequency band.

4. The method of claim 1, further comprising configuring a plurality of coexistence parameters, wherein the plurality of coexistence parameters comprises a first coexistence parameter representing an adjustment threshold for transmission power associated with the first wireless communication protocol based on an interference condition associated with the second wireless communication protocol, and wherein the plurality of coexistence parameters comprises a second coexistence parameter representing an adjustment threshold for transmission power associated with the second wireless communication protocol based on an interference condition associated with the first wireless communication protocol.

5. The method of claim 4, wherein the comparison between the first throughput and the second throughput comprises determining that the second throughput combined with the first coexistence parameter is smaller than the first throughput, and wherein adjusting the transmission parameter comprises reducing the transmission parameter by a predetermined power adjustment step based on the second throughput being smaller than the first throughput.

6. The method of claim 4, wherein the comparison between the first throughput and the second throughput comprises determining that the second throughput is greater than the first throughput combined with the second coexistence parameter, and wherein adjusting the transmission parameter comprises increasing the transmission parameter by a predetermined power adjustment step based on the second throughput being greater than the first throughput.

7. The method of claim 1, further comprising waiting for a predefined duration after applying the adjusted transmission parameter to the transmission before obtaining new throughput estimates associated with the first wireless communication protocol and the second wireless communication protocol.

8. The method of claim 1, further comprising refraining from adjusting the transmission parameter based on the comparison indicating that the first throughput corresponds to the second throughput.

9. The method of claim 1, wherein obtaining the first throughput associated with the first wireless communication protocol comprises estimating a transmission rate of the first wireless communication protocol using one or more of a channel quality indicator (CQI) or a power headroom report.

10. The method of claim 1, wherein obtaining the second throughput associated with the second wireless communication protocol comprises estimating a transmission rate of the second wireless communication protocol using a received signal strength indicator (RSSI) or a received signal-to-noise-plus-interference ratio (SNIR).

11. A non-transitory computer-readable medium comprising code that, when executed by a processor, causes the processor to perform operations comprising:
determining that a first frequency band utilized by a first wireless communication protocol is spectrally related to or at least in part affects operation with a second frequency band utilized by a second wireless communication protocol;
responsive to the determining, obtaining a first throughput of the first wireless communication protocol and a second throughput of the second wireless communication protocol;
adjusting a transmission parameter associated with the first wireless communication protocol based at least in part on a comparison between the first throughput and the second throughput; and
applying the adjusted transmission parameter to the first wireless communication protocol.

12. The non-transitory computer-readable medium of claim 11, wherein the applying comprises applying without changing the first frequency band.

13. The non-transitory computer-readable medium of claim 11, wherein the operations further comprise configuring a plurality of coexistence parameters, wherein the plurality of coexistence parameters comprises a first coexistence parameter representing an adjustment threshold for transmission power associated with the first wireless communication protocol based on an interference condition associated with the second wireless communication protocol, and wherein the plurality of coexistence parameters comprises a second coexistence parameter representing an adjustment threshold for transmission power associated with the second wireless communication protocol based on an interference condition associated with the first wireless communication protocol.

14. The non-transitory computer-readable medium of claim 13, wherein the comparison between the first throughput and the second throughput comprises determining that the second throughput combined with the first coexistence parameter is smaller than the first throughput, and wherein adjusting the transmission parameter comprises reducing the transmission parameter by a predetermined power adjustment step based on the second throughput being smaller than the first throughput.

15. The non-transitory computer-readable medium of claim 13, wherein the comparison between the first throughput and the second throughput comprises determining that the second throughput is greater than the first throughput combined with the second coexistence parameter, and wherein adjusting the transmission parameter comprises increasing the transmission parameter by a predetermined power adjustment step based on the second throughput being greater than the first throughput.

16. A system comprising:
a cellular processing circuitry; and
a coexistence circuitry configured to:
determine that a first frequency band utilized by a first wireless communication protocol is spectrally related to or at least in part affects operation with a second frequency band utilized by a second wireless communication protocol;
responsive to the determining, obtain a first throughput of the first wireless communication protocol and a second throughput of the second wireless communication protocol;
adjust a transmission parameter associated with the first wireless communication protocol based at least in part on a comparison between the first throughput and the second throughput; and
apply the adjusted transmission parameter to the first wireless communication protocol using at least in part the cellular processing circuitry.

17. The system of claim 16, wherein the coexistence circuitry is further configured to wait for a predefined duration after applying the adjusted transmission parameter to the transmission before obtaining new throughput estimates associated with the first wireless communication protocol and the second wireless communication protocol.

18. The system of claim 16, wherein the coexistence circuitry is further configured to refrain from adjusting the transmission parameter based on the comparison indicating that the first throughput corresponds to the second throughput.

19. The system of claim 16, wherein the coexistence circuitry configured to obtain the first throughput associated with the first wireless communication protocol is further configured to estimate a transmission rate of the first wireless communication protocol using one or more of a channel quality indicator (CQI) or a power headroom report.

20. The system of claim 16, wherein the coexistence circuitry configured to obtain the second throughput associated with the second wireless communication protocol is further configured to estimate a transmission rate of the second wireless communication protocol using a received signal strength indicator (RSSI) or a received signal-to-noise-plus-interference ratio (SNIR).
